(19) United States
(12) Patent Application Publication
(10) Pub. No.: US 2005/0051634 A1
(43) Pub. Date: Mar. 10, 2005

(54) System and method for identifying a payment card type using a hologram

(76) Inventor: Leland S. Englebardt II, New York, NY (US)

Correspondence Address: BAKER & BOTTS, 30 ROCKEFELLER PLAZA, NEW YORK, NY, 10112, US

(21) Appl. No.: 10/914,446

(22) Filed: Aug. 9, 2004

Related U.S. Application Data
(60) Provisional application No. 60/493,741, filed on Aug. 8, 2003.

(51) Int. Cl. G06K 19/00

(52) U.S. Cl. 235/487

(57) ABSTRACT

A payment card and method is provided that allows merchants and cardholders to visually distinguish types of payment cards using a hologram.

### CROSS-REFERENCE TO RELATED APPLICATIONS

This application claims priority to a U.S. Provisional Patent Application entitled “System for Identifying a Debit Device Using a Hologram,” filed on Aug. 8, 2003, which is incorporated by reference herein in its entirety.

### FIELD OF THE INVENTION

The present invention relates generally to the use of payment cards to purchase goods and services.

### BACKGROUND OF THE INVENTION

Payment cards have achieved great popularity with consumers and merchants because they are easy to use and obviate the need to carry large quantities of cash. Payment cards are available in many types of payment functionality. Although credit and debit cards are the most popular types of payment functionality for payment cards, other types of payment cards include, for example, charge, ATM, bank, prepaid, gift, stored-value, and purchasing cards. The foregoing list is not an exclusive list of payment card types.

A payment card transaction in a retail outlet is generally initiated by swiping the machine-readable magnetic stripe located on the payment card through a card reader. The cardholder may swipe the card himself or herself or may hand the card to the merchant for the merchant to swipe. In some cases (for example, with an ATM or smartcard transaction), the payment transaction is initiated by inserting the payment card into the card reader.

Even though the name of the issuing bank and/or the card network (for example, MASTERCARD® or VISA®) is often prominently displayed on payment cards, this information alone often does not allow the cardholder or merchant to determine the type of a particular payment card, since individual banks and card networks issue and support, respectively, many types of payment cards.

In those cases where a cardholder or merchant desire to determine the type of a particular payment card, it would be advantageous to have a payment card displaying information that, at the time a transaction is being executed, would enable such cardholder or merchant to determine the type of a particular payment card.

One way to accomplish this goal is to have a payment card type identification included within the area available for issuer customized use (i.e., the area of the card not dictated by card brand design standards). Disadvantages to this approach are that it takes away from the area available to the issuer to place attractive card program graphics on the card; it may diminish issuer brand integrity; it may dilute program name familiarity with consumers; it may require separate artwork for different payment card types associated with the same card program; and it would not promote uniformity of placement, which may make it less convenient for cardholders and merchants to quickly determine the payment card type when needed.

A need therefore exists to have a payment card displaying information that, at the time a transaction is being executed, would enable a cardholder or merchant to quickly and easily determine the type of a particular payment card, but which does not have the above-mentioned disadvantages.

### SUMMARY OF THE INVENTION

The present invention solves the foregoing need. According to one embodiment of the present invention, a payment card includes a hologram including at least a portion of an identifier that uniquely indicates a payment card type. The identifier may be wording, lettering, coloring, symbols or graphics that is superimposed on, included within, or overlapping with the hologram.

Prior to the present invention, many payment cards have used holograms as a security feature. Such holograms contain three-dimensional images that are discernable to the naked eye, but are difficult for a counterfeiter to reproduce. Accordingly, financial institutions advise merchants to inspect holograms on payment cards to see whether, for example, the image moves or changes color when viewed at different angles. It is known that security can be further enhanced by encoding the hologram with information about the issuer and cardholder and rendering such information invisible to the naked eye. It is also known that such machine-readable information can be used to authenticate transactions made using payment cards. See, e.g., U.S. Pat. No. 4,641,017 to Lopata (using an encoded hologram in conjunction with the magnetic stripe); U.S. Pat. No. 5,336,871 to Colgate (incorporating such an encoded hologram within the magnetic stripe); U.S. Pat. No. 6,328,209 to O'Boyle (using an encoded hologram in conjunction with a barcode and a magnetic stripe). Finally, the use of microholograms, where the hologram itself is invisible to the naked eye, is also known. See, e.g., U.S. Pat. No. 5,835,245 to Robillard and Chesak. Accordingly, prior to the present invention, the known uses of holograms on payment cards have thus far been directed only at preventing the fraudulent use of payment cards.

### DESCRIPTION OF THE DRAWINGS

Further objects, features and advantages of the invention will become apparent from the following description of the invention taken in conjunction with the accompanying figures showing illustrative embodiments of the invention in which:

FIG. 1 shows a hologram according to an exemplary and preferred embodiment of the present invention comprising two interlocking spheres, inscribed with the payment card type identifier word “Debit” and bordered by a field containing the words “MasterCard Debit”;

FIG. 2 shows a payment card according to an exemplary and preferred embodiment of the present invention bearing the name of the issuing bank, account number and expiration date and the hologram according to the embodiment of FIG. 1 located above the conventional payment card network logo.

Throughout the figures, unless otherwise stated, the same reference numerals and characters are used to denote like features, elements, components, or portions of the illustrated embodiments.

### DESCRIPTION OF THE INVENTION

It is therefore an object of the present invention to present a system and method that allows a cardholder or merchant to visually differentiate between different payment card types.

The invention is an improvement over known payment cards that display solely the name of the issuing bank and that of the card network, for example, MASTERCARD® or VISA®, and do not indicate to the consumer or merchant the type of payment card, for example, debit or credit. The present invention enables merchants and cardholders to visually identify and distinguish one payment card from another, and in a preferred embodiment, to visually distinguish debit cards from other payment cards.

The hologram design according to the presently claimed invention will clearly, uniquely and uniformly identify payment card type, without diminishing the brand integrity and consumer familiarity built-up in current issuer programs. The approach presents a visually compelling differentiator for card issuers, while equipping cardholders with an attractive and distinct payment card.

The new hologram design solution seamlessly integrates into current card manufacturing processes, and advantageously, the price per hologram and positioning on payment cards need not change. Additionally, the card face otherwise remains unaltered, eliminating the need for card issuers to reorient or modify existing program names or card graphics, or renegotiate standing co-brand agreements with partners. Importantly, the card with the hologram according to the present invention leverages existing business practices where merchants check the hologram prior to accepting payment cards for purchases, ensuring fast and proper payment card identification. Finally, a card with a hologram according to the present invention maximizes the card area available to the issuer for customized use.

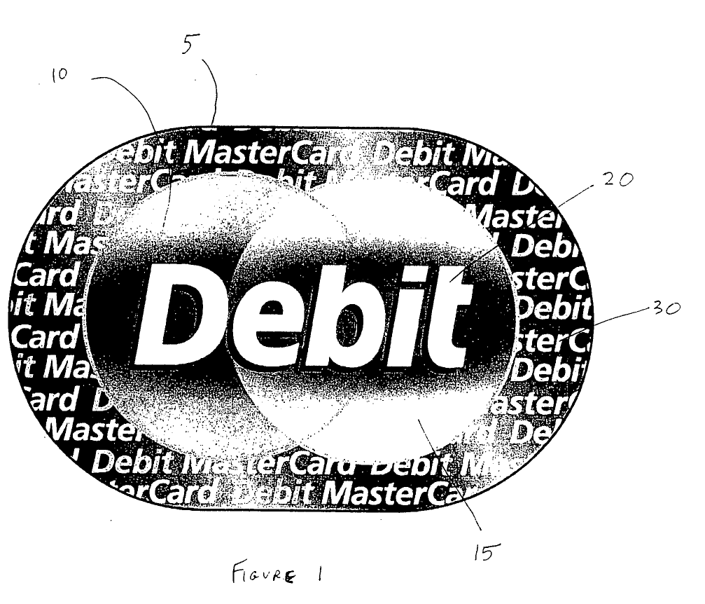

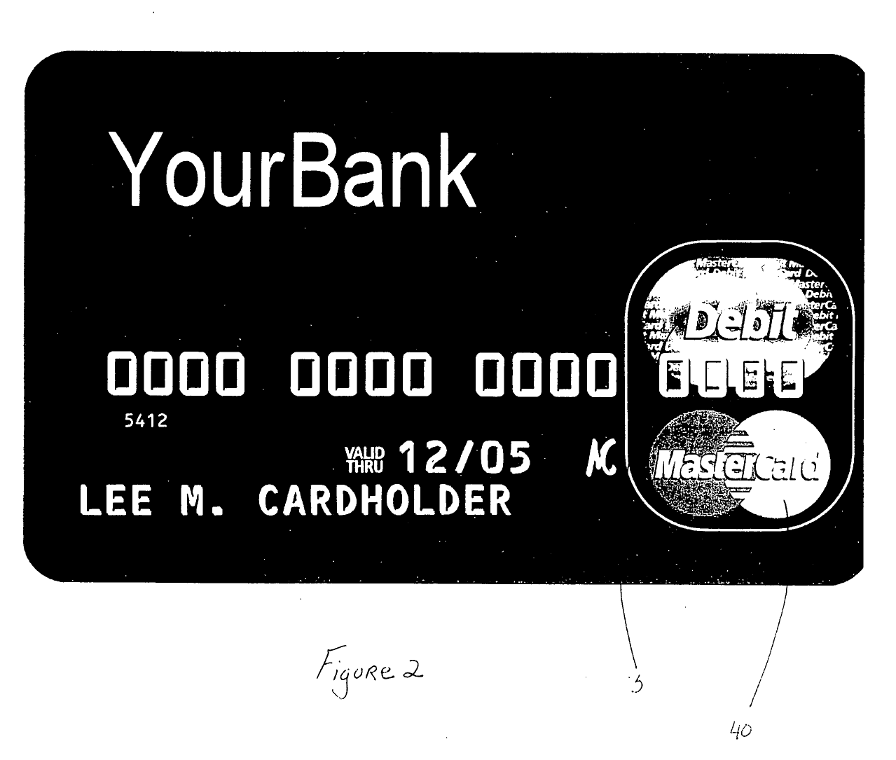

In an exemplary and preferred embodiment of the present invention, as illustrated in FIGS. 1 and 2, the present invention comprises a payment card with the word “Debit” 20 in approximately fourteen point italic type in holographic form, contrasted against a hologram background 10 that includes two interlocking three-dimensional spheres 15. As shown in detail in FIG. 1, preferably, the word “Debit” 20 appears in white against a different colored or multicolored 3-D hologram background 10 to enhance contrast. As also shown in more detail in FIG. 1, the word “Debit” 20 also has a dropped shadow to enhance its visibility and the area of the hologram around the spheres preferably contains the words “Debit MasterCard” 30 in smaller letters. In the embodiment shown in FIG. 2, the identifying hologram 5 is placed above the symbol identifying the issuing card network 40, in this case MASTERCARD®, which is shown located in the lower right hand corner of the card. However, various combinations of holograms and identifying elements could be employed, including the use of more than one hologram for identification purposes.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

1. A payment card comprising:
at least one face thereon;
at least one holographic marking disposed on the at least one face; and
at least a portion of an identifier included within the at least one holographic marking indicating a payment card type.

2. The payment card of claim 1, wherein the word “Debit” is included within the at least one of said holographic markings.

3. The payment card of claim 1, wherein the identifier indicating payment card type is superimposed on a logo of a payment card network.

4. A method for identifying different types of payment cards, comprising the steps of:
placing at least one holographic marking on at least one face of a payment card; and,
indicating the payment card type using at least one of said holographic markings.

5. The method of claim 3, wherein said step of indicating the payment card type further comprises the step of superimposing the word “Debit” on at least one of said holographic markings.

6. The method of claim 3, wherein the step of indicating the payment card type comprises placing a payment card type identifier superimposed on a logo of a payment card network.

7. A payment card comprising:
at least one face thereon;
at least one holographic marking disposed on the at least one face; and
at least a portion of an identifier included within the at least one holographic marking uniquely indicating a payment card type.

8. The payment card of claim 1, wherein the word “Debit” is included within the at least one of said holographic markings.

9. The payment card of claim 1, wherein the identifier indicating payment card type is superimposed on a logo of a payment card network.

10. A method for identifying different types of payment cards, comprising the steps of:
placing at least one holographic marking on at least one face of a payment card; and,
uniquely indicating the payment card type using at least one of said holographic markings.

11. The method of claim 3, wherein said step of indicating the payment card type further comprises the step of superimposing the word “Debit” on at least one of said holographic markings.

12. The method of claim 3, wherein the step of indicating the payment card type comprises placing a payment card type identifier superimposed on a logo of a payment card network.
